(19) United States
(12) Patent Application Publication
(10) Pub. No.: US 2011/0249669 A1
(43) Pub. Date: Oct. 13, 2011

(54) METHOD FOR SERVICE INTER-WORKING AND SESSION CHANNEL ESTABLISHMENT, INTER-WORKING SELECTION FUNCTION MODULE AND DEVICE

(75) Inventors: Guojun Xu, Nanjing (CN); Yonggang Bian, Nanjing (CN); Lunjian Mu, Nanjing (CN); Jue Wang, Nanjing (CN); Cheng Huang, Shenzhen (CN); Gang Liang, Nanjing (CN); Yongjing Zhang, Nanjing (CN)

(73) Assignee: Huawei Technologies Co., Ltd., Shenzhen (CN)

(21) Appl. No.: 13/163,146

(22) Filed: Jun. 17, 2011

Related U.S. Application Data
(63) Continuation of application No. PCT/CN2009/073662, filed on Sep. 1, 2009.

(30) Foreign Application Priority Data
Dec. 19, 2008 (CN) 200810241610.5

(51) Int. Cl. H04L 12/66

(52) U.S. Cl. 370/352

(57) ABSTRACT

A method for service inter-working and session channel establishment, an Inter-working Selection Function (ISF) module and device are provided. The method for service inter-working includes: receiving content which is corresponding to at least two media types and is sent by a calling party; and sending, according to the media types of the content, the content to Inter-Working Function (IWF) modules each corresponding to one media type, so that the IWF modules send the received content to a called party. In one aspect, a Converged IP Message (CPM) service may have sessions with a plurality of non-CPM services, thereby improving user experience; in another aspect, when the calling party intends to change the media types between the calling party and the called party with which the calling party has processed the service inter-working, it can be achieved just by directly changing the media types without disconnecting the session with the called party in advance.

### CROSS-REFERENCE TO RELATED APPLICATIONS

This application is a continuation of International Application No. PCT/CN2009/073662, filed on Sep. 1, 2009, which claims priority to Chinese Patent Application No. 200810241610.5, filed on Dec. 19, 2008, both of which are hereby incorporated by reference in their entireties.

### FIELD OF THE INVENTION

The present invention relates to the field of communications, and in particular, to a method for service inter-working and session channel establishment, and an Inter-working Selection Function (ISF) module and device.

### BACKGROUND OF THE INVENTION

The Converged IP Message (CPM) is a converged message service covering multiple message service experiences, and the CPM further provides voice and video capabilities. In addition, the CPM further has a capability of intercommunicating with current conventional message services and the Voice over IP and Video over IP (VoIP).

In an implementation framework of the CPM, two function modules, namely, an ISF module and an Inter-Working Function (IWF) module, support the intercommunication function. The ISF module implements a selection for the intercommunication function. When a message or a session INVITE is arrived, if a called party satisfies a scene requiring the intercommunication, the ISF module needs to select an appropriate IWF module according to the type and size of the message, a strategy of an operator, or a configuration or strategy of the called party, and the IWF module converts and then sends the message or the session INVITE to a terminal of the called party.

In the prior art, when a CPM user initiates a session request to a non-CPM user, the ISF module forwards the session request to one or more service intercommunication modules of the non-CPM user according to the service request type of the session request of the initiator. For example, when a CPM user requests for having a text chat with a non-CPM user, if the non-CPM user activates an Instant Messaging and Presence Service (IMPS) and a SIP Instant Message and Presence Leveraging Extensions Instant Messaging (SIMPLE IM) service, the ISF module sends the session request to IWF module corresponding to the IMPS service and IWF module corresponding to the SIMPLE IM service, and then the IWF module corresponding to the IMPS service and the IWF module corresponding to the SIMPLE IM service convert and send the session request to an appropriate service server. When any one of the IWF modules returns a reply, it indicates that the called non-CPM user receives the request of using the service corresponding to the IWF module, and inter-working requests sending to other services are cancelled automatically.

In the implementation of the present invention, the inventor finds that the current CPM service can only carry out a session between one non-CPM service and the CPM, so that the user experience is poor, and the development of the CPM service is limited.

### SUMMARY OF THE INVENTION

Embodiments of the present invention provide a method for service inter-working, a method for inter-working session channel establishment, an ISF module, and a device, so that, in one aspect, the CPM service may have sessions with a plurality of non-CPM users, thereby improving user experience; in another aspect, when a calling party intends to change media type between the calling party and called parties with which the calling party has processed the service inter-working, it may be achieved just by directly changing the media types without disconnecting the sessions with the called parties in advance.

An embodiment of the present invention provides a method for service inter-working, where the method includes: receiving content which is corresponding to at least two media types and is sent by a calling party; and sending, according to media types of the content, the content to IWF modules each corresponding to information about one media type, so that the IWF modules send the received content to a called party.

An embodiment of the present invention further provides a method for inter-working session channel establishment, where the method includes: receiving a session INVITE message sent by a calling party, where the session INVITE message carries information about the called party and information about at least two media types used in the session; according to information about services activated by the called party and information about media types carried in the session INVITE message, sending an INVITE message carrying information about the called party and information about media type to IWF modules each corresponding to information about one media type and information about services activated by the called party, so that the IWF modules having received the INVITE message convert the INVITE message and then send the converted INVITE message to the called party; and receiving an agreement response message returned by the called party.

Another embodiment of the present invention further provides a method for inter-working session channel establishment, where the method includes: receiving a session INVITE message sent by a calling party, where the session INVITE message carries information about the called party, information about media type of the current session, information about media types used in the session, and an identifier of the current session; sending, according to the information about the media types used in the session and carried in the session INVITE message and the information about the services activated by the called party, an INVITE message carrying the information about the called party, the information about media type used in the session, and the identifier of the current session to IWF modules each corresponding to information about one media type used in the session and information about services activated by a called party, so that the IWF modules having received the INVITE message send the INVITE message to the called party; and receiving an agreement response message returned by the called party.

An embodiment of the present invention further provides an ISF module, where the ISF module includes: a content receiving unit, configured to receive content which is corresponding to at least two media types and is sent by a calling party; and a content sending unit, configured to send, according to the media types of the content, the content to IWF modules each corresponding to information about one media type, so that the IMF modules send the received content to a called party.

Another embodiment of the present invention provides an ISF module, where the ISF module includes: a message receiving unit, configured to receive a session INVITE message sent by a calling party, where the session INVITE message carries information about the called party, information about media type of the current session, information about media types used in the session, and an identifier of the current session; and a message sending unit, configured to, according to the information about services activated by the called party and the information about the media types carried in the session INVITE message, send an INVITE message carrying the information about the called party, information about media type, and the identifier of the current session to IWF modules each corresponding to information about one media type in the session and information about services activated by a called party, where the IWF modules having received the INVITE message convert the INVITE message and then send the converted INVITE message to the called party; and the message receiving unit is further configured to receive an agreement response message returned by the called party.

Still another embodiment of the present invention provides an ISF module, where the ISF module includes: a receiving unit, configured to receive a session INVITE message sent by a calling party, where the session INVITE message carries information about the called party and information about at least two media types used in the session; and a sending unit, configured to, according to the information about services activated by the called party and the information about media types carried in the session INVITE message, send an INVITE message carrying the information about the called party and information about media type to IWF modules each corresponding to information about one media type and information about services activated by a called party, so that the IWF modules having received the INVITE message convert the INVITE message and then send the converted INVITE message to the called party; and the receiving unit is further configured to receive an agreement response message returned by the called party.

An embodiment of the present invention further provides a device, where the device includes: an ISF module, configured to receive a message sent by a calling party, where the message carries content of at least two media types, split, according to the media types of content, the message into messages including content of one media type, and send the split message including content of one media type to a corresponding IWF module; and the IWF module, configured to send the split message including the content of one media type to a called party.

It may be known from the above embodiments that, according to the embodiments of the present invention, the ISF module may receive content which is corresponding to at least two media types and is sent by the calling party, and, according to the media types of the content, send the content to the IWF modules each corresponding to information about one media type, so that the IWF modules send the received content to the called party. Therefore, the CPM service may be in a converged use with multiple non-CPM services and the calling party may be communicated with the called party for content of multiple media types in the same session, and the CPM user and the non-CPM user may convert the media types in the session process, thereby improving communication experience between the CPM service user and the non-CPM service user, extending the use of the CPM service by the CPM user, and further increasing the inter-working between the CPM service and the non-CPM service. According to embodiments of the present invention, the session channel based on the same session identifier may be established, so that, when the calling party intends to change the media types between the calling party and the called party with which the calling party has processed the service inter-working, it can be achieved just by directly changing the media types without disconnecting the session with the called party in advance.

### BRIEF DESCRIPTION OF THE DRAWINGS

FIG. 1 is a flow chart of a method for service inter-working according to an embodiment of the present invention;

FIG. 2 is a flow chart of a method for establishing a service inter-working session channel that includes a plurality of media types according to an embodiment of the present invention;

FIG. 3 is a flow chart of a method for establishing a service inter-working session channel that changes media types in an existing session according to an embodiment of the present invention;

FIG. 4 is a signaling flow chart of a method for establishing a service inter-working session channel that adds media types in an existing session according to an embodiment of the present invention;

FIG. 5 is a signaling flow chart of a method for establishing a service inter-working session channel that includes a plurality of media types according to an embodiment of the present invention;

FIG. 6 is a signaling flow chart of a method for establishing a service inter-working session channel that changes media types in an existing session according to an embodiment of the present invention;

FIG. 7 is a structural view of an ISF module according to an embodiment of the present invention;

FIG. 8 is a structural view of another ISF module according to an embodiment of the present invention;

FIG. 9 is a structural view of still another ISF module according to an embodiment of the present invention; and

FIG. 10 is a structural view of a device implementing service inter-working according to an embodiment of the present invention.

### DETAILED DESCRIPTION OF THE EMBODIMENTS

In order to make objectives, technical solutions, and advantages of the present invention more comprehensible, a detailed description of the present invention is given below with reference to the accompanying drawings.

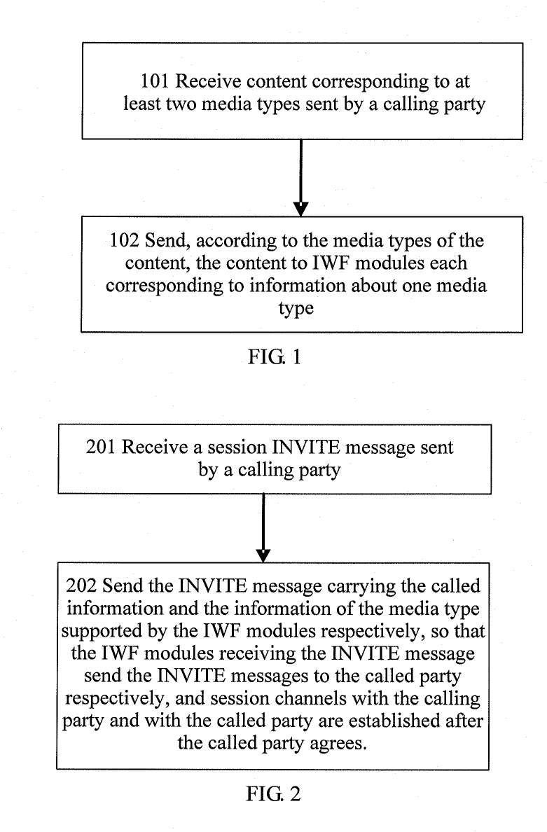

The present invention provides a method for service inter-working according to an embodiment of the present invention, and as shown in FIG. 1, the method includes the following steps.

In step 101, content which is corresponding to at least two media types and is sent by a calling party is received.

In step 102, according to the media types of the content, the content is sent to IWF modules each corresponding to information about one media type, so that the IWF modules send the received content to a called party.

Furthermore, according to the embodiment of the present invention, before step 101, the method further includes: establishing a session channel between an ISF module and the calling party and a session channel between the ISF module and the called party, so that, the calling party may send content of a plurality of media types through the session channel. The establishing a session channel between an ISF module and the calling party and a session channel between the ISF module and the called party specifically includes: receiving, by an ISF module, a session INVITE message sent by the calling party, where the session INVITE message carries information about the called party and information about at least two media types used in a session; sending, according to the information about the media types in the session INVITE message and the information about services activated by the called party, an INVITE message carrying the information about the called party and the information about media type to IWF modules each corresponding to information about one media type and information about services activated by the called party, so that the IWF modules having received the INVITE message send the INVITE message to the called party; and establishing a session channel between the ISF module and the calling party and a session channel between the ISF module and the called party after receiving an agreement response message. The information about media type in the INVITE message is the information about the media type supported by each of the IWF modules receiving the INVITE message.

It may be known from the above embodiment that, the ISF module in the embodiment of the present invention may receive the content of at least two media types sent by the calling party, and send, according to the media types of the content, the content to the IWF modules each corresponding to information about one media type, so that the calling party may send the content corresponding to a plurality of media types in the same session. At the same time, the CPM service may be converged with multiple non-CPM services, and afterwards, interaction is performed, thereby improving communication experience between the CPM service user and the non-CPM users, extending the use of the CPM service by the CPM user, and further increasing inter-working between the CPM service and the non-CPM service.

FIG. 2 is a flow chart of a method for establishing a service inter-working session channel that includes a plurality of media types according to an embodiment of the present invention. The method includes the following steps.

In step 201, a session INVITE message sent by a calling party is received, where the session INVITE message carries information about the called party and information about at least two media types used in the session.

In step 202, an INVITE message carrying the information about the called party and information about media type is sent, according to the information about services activated by the called party and the information about the media types carried in the session INVITE message, to IWF modules each corresponding to information about one media type and information about services activated by a called party, so that the IWF modules having received the INVITE message convert the INVITE message and then send the converted INVITE message to the called party respectively, and a session channel between an ISF module and the calling party and a session channel between the ISF module and the called party are established after the called party agrees. The information about media type in the INVITE message is the information about media type supported by each of the IWF modules receiving the INVITE message.

It may be known from the above embodiment that, according to the embodiment of the present invention, the ISF module may, according to the session INVITE message from the calling party, send an INVITE message carrying the information about the called party and the information about media type to the IWF modules each corresponding to information about one media type in the session INVITE message and the information about services activated by the called party, so that the IWF modules having received the INVITE message send the INVITE message to the called party respectively, and a session channel between an ISF module and the calling party and a session channel between the ISF module and the called party are established after the called party agrees, so as to further enable the calling party to send the content including at least two media types to the ISF module after the session channel establishment is completed.

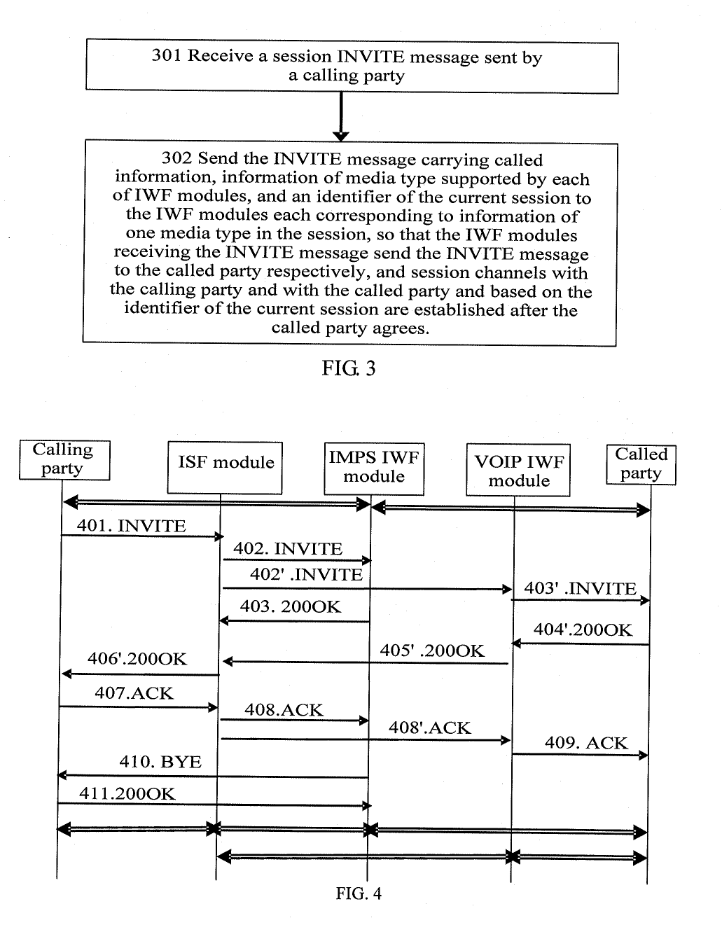

FIG. 3 is a flow chart of a method for establishing a service inter-working session channel that changes media types in an existing session according to an embodiment of the present invention. The method includes the following steps.

In step 301, a session INVITE message sent by a calling party is received, where the session INVITE message carries information about the called party, information about the media type of the current session, information about media types used in the session, and an identifier of the current session.

In step 302, an INVITE message carrying the information about the called party and the information about media type used in the session is sent, according to the information about the media types used in the session and carried in the session INVITE message and the information about services activated by the called party, to IWF modules each corresponding to information about one media type used in the session and information about services activated by a called party, so that the IWF modules having received the INVITE message send the INVITE message to the called party respectively, and a session channel based on the identifier of the current session between an ISF module and the calling party and a session channel between the ISF module and the called party are established after the called party agrees. The information about media type in the INVITE message is the information about the media type supported by each of the IWF modules receiving the INVITE message.

It may be seen from the above embodiment that, according to the embodiment of the present invention, the session channels based on the same session identifier may be established, so that when the calling party intends to change the media types between the calling party and the called party with which the calling party has processed the service inter-working, if the non-CPM service in the existing session does not support the media type after changing, the ISF module directly reselects the IWF module according to a manner of changing the media types by using an existing routing path without disconnecting the session with the called party in advance and reestablishing a session link channel.

FIG. 4 is a flow chart of a method for establishing a service inter-working session channel that adds media types in an existing session. If a CPM user is having an IMPS session with a non-CPM user through an IMPS IWF module, that is to say, a session channel between a calling party and a called party and passing through the IMPS IWF module exists, and the CPM user, that is, the calling party, hopes to add a new media type being voice to the existing IMPS session. The method includes the following steps.

In step 401, the calling party sends a session INVITE message to an ISF module corresponding to the calling party through a CPM server, where the session INVITE message carries a session identifier of the current session, and information about the media types (text and voice in this embodiment) in the session.

In step 402, the ISF module judges, according to the session identifier of the current session and the information about the media types in the session in the session INVITE message, that the new media type is added into the current session, and sends a first INVITE message to an IMPS IWF module to request for establishing a session with the IMPS IWF module. The first INVITE message includes the identifier of the current session, the media type of the session being text, and information about the called party. Specifically, the ISF module determines that the media type of the current session is the text according to the session identifier of the current session, and the media types in the session include two media types, namely, the text and the voice; therefore, the session INVITE message sent by the calling party in step 401 is adding the new media type being voice into the current session.

The ISF module inquires the type of services activated by the called party through the Home Subscriber Server (HSS) and acquires that the called party activates two non-CPM services, namely, the IMPS service and the VOIP service, but does not activate the CPM service. Therefore, according to the information about the media types included in the session INVITE message sent by the calling party, it is determined that a combination of the non-CPM services, that is, the IMPS service and the VOIP service activated by the called party may satisfy the session INVITE message from the calling party.

In step 403, the IMPS IWF module receives the first INVITE message, and according to the identifier of the current session, the media type of the session being text, and the information about the called party in the first INVITE message, it is determined that a session with the called party corresponding to the information about the called party in the first INVITE message exists, and the media type in the session is also the text; therefore, only a first 200 OK response is returned to the ISF module, so as to agree to establish a session based on the identifier of the current session with the ISF module, and the media type of the session already established between the IMPS and the ISF module is text, that is, the establishment of the session channel based on the identifier of the current session with the called party corresponding to the information about the called party is maintained.

Definitely, in this step, after receiving the first INVITE message from the ISF module, the IMPS IWF module may not made any judgment. When step 403 is performed, a third INVITE message, which is converted from the first INVITE message by the IMPS IWF module, according to a protocol supported by the IMPS IWF module is forwarded to an IMPS server to which the called party belongs, according to the information about the called party in the first INVITE message, and the IMPS server to which the called party belongs determines that the called party has established the session having the media type being the text with the IMPS.

In this embodiment, the session INVITE message received by the ISF module includes two media types: the text and the voice; therefore, when the ISF module performs step 402, step 402′ is also performed, and the corresponding IWF module performs the corresponding process according to step 402′.

In step 402′, the ISF module sends a second INVITE message to a VOIP IWF module to request for establishing a session with the VOIP IWF module. The second INVITE message includes the identifier of the current session, the media type of the session being voice, and information about the called party.

In step 403′, after the VOIP IWF module receives the second INVITE message, according to the identifier of the current session, the media type of the session being voice, and the information about the called party in the second INVITE message, it is determined that a session with the called party corresponding to the information about the called party in the second INVITE message does not exist; therefore, a fourth INVITE message supported by a VOIP IWF protocol and converted by the VOIP IWF module is sent to the called party through a VOIP server to which the called party belongs, so as to request for establishing a session based on the identifier of the current session with the called party.

In step 404′, the called party returns a response to the VOIP IWF module through the VOIP server to which the called party belongs, and agrees to establish a session having the media type being voice based on the identifier of the current session with the IWF module.

Definitely, when step 403′ is performed, the VOIP IWF module may not make any judgment. When the sending the fourth INVITE message of step 403′ is performed, the fourth INVITE message, which is converted from the second INVITE message by the VOIP IWF module is sent to the VOIP server to which the called party belongs, according to the information about the called party in the second INVITE message, and the VOIP server to which the called party belongs determines that the called party does not establish a session having the media type being voice with the VOIP IWF module, and sends the fourth INVITE message to the called party to request for establishing a session based on the identifier of the current session with the called party.

If the VOIP IWF module sends the fourth INVITE message to the VOIP server to which the called party belongs, the VOIP server to which the called party belongs judges that the called party does not establish a session having the media type being voice with the VOIP of the calling party, and the VOIP server to which the called party belongs forwards the fourth INVITE message to the called party, receives an agreement response of the called party, and then returns a 200 OK response to the VOIP IWF module.

In step 405′, the VOIP IWF module returns the 200 OK response to the ISF module and agrees to establish the session having the media type being voice and based on the identifier of the current session with the ISF module.

In step 406′, the ISF module receives two 200 OK responses in steps 403 and 405′, and then sends a 200 OK response to the calling party.

In step 407, the calling party receives the 200 OK response returned from the ISF module, and then sends an acknowledgment (ACK) message to the ISF module.

In steps 408 and 408′, the ISF module respectively sends the ACK message to the IMPS IWF module and the VOIP IWF module to which the called party belongs.

In step 409, the VOIP IWF module sends an ACK message to the called party through the VOIP server to which the called party belongs.

In step 410, the IMPS IWF module sends a session end (BYE) message to the calling party, and cancels the session, which is based on the identifier of the current session, between the IMPS IWF module and the calling party. Definitely, steps 409 and 410 have no performing sequence, as long as step 410 is performed after step 408.

In step 411, the calling party receives the BYE message sent by the IMPS IWF module, and then returns a 200 OK response to the ISF module.

Here, the establishment of session channels having a plurality of media types in the same session identifier is completed. Definitely, it may be seen from the figure that, the session channels between the ISF module and the called party include: the session channel between the ISF module and the called party passing through the IMPS IWF module, and the session channel between the ISF module and the called party passing through the VOIP IWF module. After the calling party sends the content including text and voice to the ISF module, the ISF module sends the content based on the text to the IMPS IWF module, the IMPS IWF module sends the content based on the text to the called party through the IMPS server to which the called party belongs; and the ISF module sends the content based on the voice to the VOIP IWF module, the VOIP IWF module sends the content based on the voice to the called party through the VOIP server to which the called party belongs.

It may be seen from the above embodiment that, the ISF module is introduced in the present invention, thereby realizing the inter-working of content of the plurality of media types based on the same session identifier. Furthermore, the existing session has no need to be disconnected when the media type of the existing session is changed, for example, when a new media type is added, and during the process of changing, the calling party and the called party may still be in inter-working, thereby improving user experience. Moreover, a CPM client establishes the text and voice session with a non-CPM client through the ISF module, and a plurality of IWF modules participates in the session. Two non-CPM clients may be on one terminal of the called party, or may be on different terminals of the called party.

It may be seen from this embodiment, when the CPM user is having a session with the non-CPM user and the CPM user hopes to add a new media type into the session, no matter the inter-working occurs at an initiator CPM network side or at the called party side, the ISF module of the corresponding party is responsible for performing a service selection of newly adding the media type into the session.

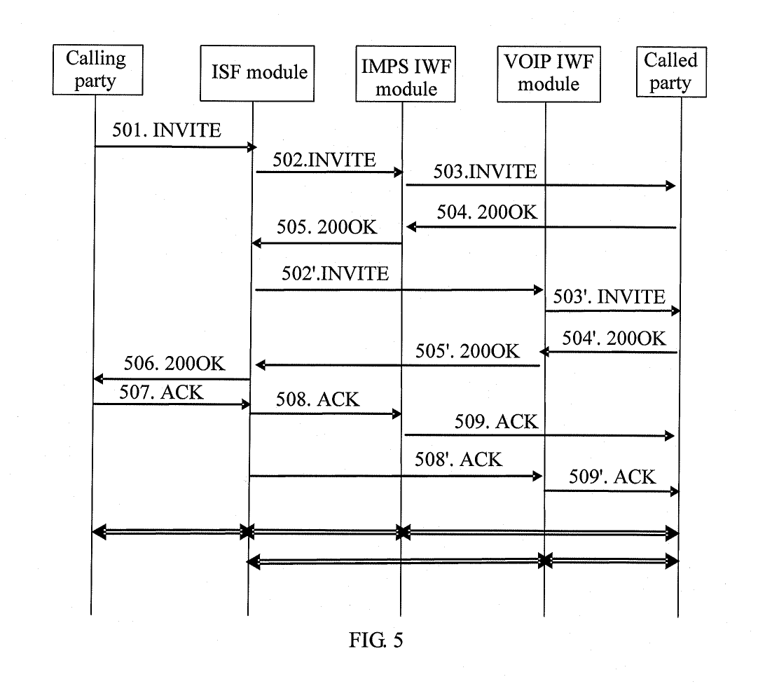

FIG. 5 is a flow chart of a method for establishing a service inter-working session channel that includes the plurality of media types according to an embodiment of the present invention. A CPM user serving as a calling party initiates establishment of a session having a plurality of media types to a non-CPM user serving as a called party. As for the called party, no separate non-CPM service can satisfy the request, so a plurality of non-CPM services are required to be combined to satisfy the request. In this embodiment, the inter-working occurring on the calling party is taken as an example to describe, and a specific process includes the following steps.

In step 501, the calling party sends a session INVITE message to an ISF module through a CPM server, where the session INVITE message carries information about media types (text and voice in this embodiment) of establishing the session and information about the called party. When performing this step, the CPM server to which the calling party belongs judges, according to information about services activated by the called party, that the called party does not activate the CPM service or that it is required to reach the called party in an inter-working manner due to other reasons (for example, the networks of the called party does not activate the CPM service); therefore, the session INVITE message is required to be sent to the ISF module.

In step 502, according to the information about the called party in the session INVITE message, the ISF module inquires, from the HSS to which the calling party belongs, the type of services activated by the called party, so as to acquire that the called party activates two non-CPM services, namely, an IMPS service and a VOIP service, but does not activate the CPM service. Therefore, according to the media types included in the session INVITE message sent by the calling party, it is determined that a combination of the non-CPM services, that is, the IMPS service and the VOIP service activated by the called party may satisfy the session INVITE message from the calling party. The ISF module sends a first INVITE message to an IMPS IWF module. The first INVITE message includes the media type of the session being text, and the information about the called party.

In step 503, the IMPS IWF module receives the first INVITE message, sends, according to the information about the called party in the first INVITE message, a second INVITE message converted by the IMPS IWF module according to a protocol supported by the IMPS IWF module through an IMPS server to which the called party belongs, and requests for establishing a session having the media type being text with the called party.

In step 504, the called party returns a response to the IMPS IWF module through the IMPS server to which the called party belongs, and agrees to establish the session having the media type being text with the IMPS IWF module.

In step 505, the IMPS IWF module returns a 200 OK response to the ISF module, and agrees to have the session having the media type being text with the ISF module.

In step 502′, according to the information about the called party in the session INVITE message, the ISF module inquires the type of services activated by the called party from an HSS belonged to the calling party, so as to acquire that the called party activates two non-CPM services, namely, the IMPS service and the VOIP service, but does not activate the CPM service. Therefore, according to the media types included in the session INVITE message sent by the calling party, it is determined that a combination of the non-CPM services, that is, the IMPS service and the VOIP service activated by the called party may satisfy the session INVITE message from the calling party. The ISF module sends a third INVITE message to a VOIP IWF module. The third INVITE message includes the media type of the session being voice, and the information about the called party.

In step 503′, the VOIP IWF module receives the third INVITE message, sends, according to the information about the called party in the third INVITE message, the third INVITE message converted by the VOIP IWF module according to a protocol supported by the VOIP IWF module through a VOIP server to which the called party belongs, and request for establishing a session having the media type being voice with the called party.

In step 504′, the called party returns a response to the VOIP IWF module through the VOIP server to which the called party belongs, and agrees to establish the session having the media type being voice with the VOIP IWF module.

In step 505′, the VOIP IWF module returns a 200 OK response to the ISF module, and agrees to have the session having the media type being voice with the ISF module.

In step 506, the ISF module receives two 200 OK responses in steps 505 and 505′, and then sends a 200 OK response to the calling party.

In step 507, the calling party receives the 200 OK response returned from the ISF module, and then sends an ACK message to the ISF module.

In steps 508 and 508′, the ISF module respectively sends the ACK message to the IMPS IWF module and the VOIP IWF module belonged to the calling party.

In step 509, the IMPS IWF module sends the ACK message to the called party through the IMPS server to which the called party belongs.

Step 509′ is similar to step 509, and will not be described herein again.

Here, the establishment of session channels between the ISF module and the calling party and between the ISF module and the called party, and having the media types being text and voice is completed. Definitely, it may be seen from the figure that, the session channels between the ISF module and the called party include: the session channel between the ISF module and the called party passing through the IMPS IWF module, and the session channel between the ISF module and the called party passing through the VOIP IWF module. After the calling party sends the content having the media types being text and voice to the ISF module, the ISF module sends the content based on the text to the IMPS IWF module, and the IMPS IWF module sends the content based on the text to the called party; and the ISF module sends the content based on the voice to the VOIP IWF module, and the VOIP IWF module sends the content based on the voice to the called party.

It may be seen from the above embodiment that, the ISF module is introduced in the present invention, so that, the establishment of the session channel of a plurality of media types based on the same session identifier is implemented, and the calling party may send the content corresponding to the plurality of media types in the same session.

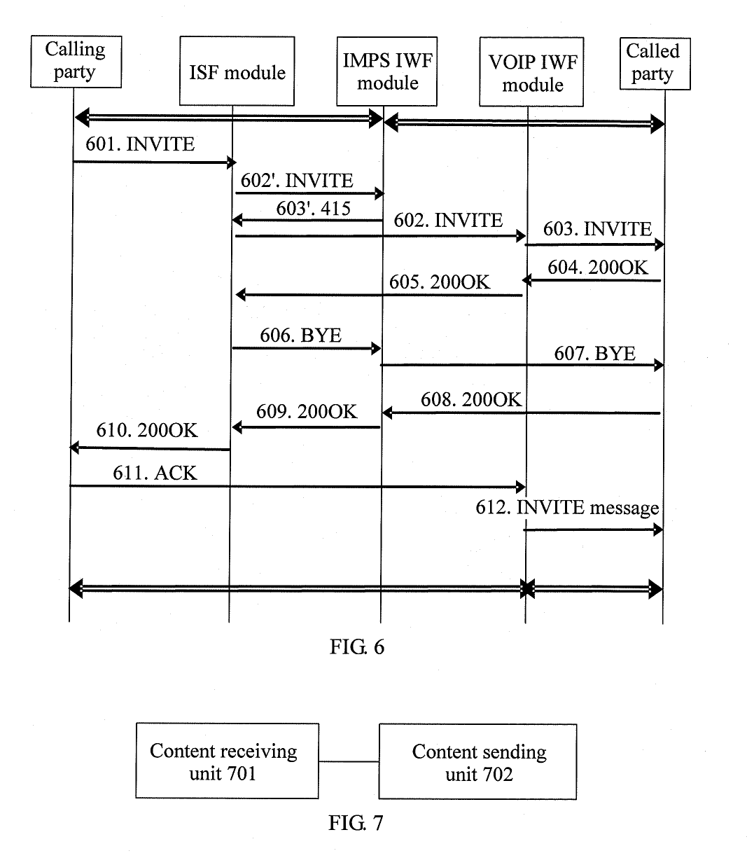

FIG. 6 is a flow chart of another method for establishing a service inter-working session channel that changes media types in an existing session according to an embodiment of the present invention. In this embodiment, a session between a calling party and a called party through an IMPS IWF module exists, that is, a session channel between the calling party and the called party passing through an IMPS IWF module exists. A CPM user serving as the calling party hopes to change the session having the media type being text with a non-CPM user to having the media type being voice. A specific process is described as follows.

In step 601, the calling party sends a session INVITE message to an ISF module corresponding to the calling party through a CPM server, where the session INVITE message carries information about a session identifier of the current session, the media type (text in this embodiment) of the current session, and the media type (voice in this embodiment) used in the session.

In step 602′, the ISF module sends the session INVITE message to the IMPS IWF module, where the session INVITE message carries information about the called party, information about the media type of the current session, information about the media type used in the session, and the identifier of the current session.

In step 603′, according to the information about the media type (voice in this embodiment) used in the session, the IMPS IWF module judges that the IMPS service does not support the voice service, and sends a 415 message to the ISF module.

In step 602, the ISF module sends a second INVITE message to a VOIP IWF module according to the session identifier of the current session, the information about the media type (text in this embodiment) of the current session, information about services activated by the called party, and the information about the media type (voice in this embodiment) used in the session in the session INVITE message. The second INVITE message includes the identifier of the current session, the media type of the session being voice, and the information about the called party.

In this step, the ISF module judges that the service IMPS in the current session of the called party does not support a voice session according to the session identifier of the current session, and the ISF module, according to the information about the called party in the session INVITE message, inquires the type of services activated by the called party from an HSS to which the calling party belongs, so as to acquire that the called party activates non-CPM services being VOIP, but does not activates the CPM service. Therefore, according to the information about the media type used in the session and carried in the session INVITE message sent by the calling party, it is determined that the non-CPM service being VOIP activated by the called party may satisfy the session INVITE message of the calling party.

A judgment may not be made in this step, but steps 602′ and 603′ are performed first, that is, the ISF module sends the session INVITE message to the IMPS IWF module according to the session identifier of the current session, and the IMPS IWF returns a 415 reply indicating that the IMPS service does not support the voice service, and then step 602 is performed.

In step 603, after the VOIP IWF module receives the second INVITE message, according to the identifier of the current session, the media type of the session being voice in the second INVITE message, the called party information in the second NVITE message determines that a session with a called party does not exist; therefore, a third INVITE message, which is converted from a second INVITE message through a VOIP IWF protocol, is sent to the called party through a VOIP server to which the called party belongs to request for establishing a session based on the identifier of the current session with the called party.

In step 604, the called party returns a response to the VOIP IWF module through the VOIP server to which the called party belongs, and agrees to establish, a session having the media type being voice, with the VOIP IWF module, where the session is based on the identifier of the current session.

Definitely, when step 603 is performed, the VOIP IWF module may not make the judgment. When step 603 is performed, the third INVITE message, which is converted from a second message by the VOIP IWF module, is sent to the called party through the VOIP server to which the called party belongs, according to the information about the called party in the second INVITE message, and the VOIP server to which the called party belongs determines that the called party does not establish the session having the media type being voice of the current session identifier with the VOIP IWF module, forwards the third INVITE message to the called party, and returns a first 200 OK response to the VOIP IWF module after an agreement response of the called party is received.

In step 605, the VOIP IWF module returns the first 200 OK response to the ISF module and agrees to establish the session having the media type being voice and based on the identifier of the current session with the calling party.

In step 606, the ISF module sends a BYE message to the IMPS IWF module of the calling party, and requests for disconnecting the sessions with the calling party and the called party having the media type being text.

In step 607, the IMPS IWF module of the calling party sends a disconnection request to the called party, and requests for disconnecting the session between IMPS IWF and the calling party and for disconnecting the session between the IMPS IWF and the called party, where the media type of the session is text.

In step 608, the called party sends a response to the IMPS IWF module and agrees to disconnect a session having the media type being text with the calling party.

In step 609, the IMPS IWF module sends a 200 OK response to the ISF module and agrees to disconnect the session having the media type being text with the calling party.

In step 610, the ISF module sends a 200 OK response to the calling party to indicate that the called party agrees to disconnect the session having the media type being text with the calling party.

In steps 611 to 612, the calling party sends an ACK message to the VOIP IWF module, and the VOIP IWF module sends the ACK message to the called party after conversion.

Here, in the same session identifier, the change of the media type being text into the media type being voice is completed. The message, which includes the voice and is sent by the calling party to the VOIP IWF of the calling party, may be forwarded to the called party through the VOIP IWF of the calling party, and the received message including the voice of the called party is sent to the calling party.

FIG. 7 is an ISF module according to an embodiment of the present invention, and the ISF module includes a content receiving unit 701, and a content sending unit 702.

The content receiving unit 701 is configured to receive content which is corresponding to at least two media types and is sent by a calling party. The content sending unit 702 is configured to send, according to the media types of the content, the content to IWF modules each corresponding to information about one media type, so that the IMF modules send the received content to a called party.

Definitely, in other embodiments of the present invention, the content receiving unit 701 is further configured to receive a session INVITE message sent by the calling party, where the session INVITE message carries information about the called party and information about at least two media types used in the session. The content sending unit 702 is further configured to send, according to the information about media types used in the session in the session INVITE message, an INVITE message carrying the information about the called party and the information about the media type to IWF modules each corresponding to information about one media type and information about services activated by the called party, so that, the IWF modules having received the INVITE message send the INVITE message to the called party respectively. The content receiving unit 701 is further configured to receive an agreement response message returned by the called party.

Furthermore, the content receiving unit 701 is further configured to acquire, according to the information about the called party, the information about services activated by the called party.

Through the above ISF module, a session channel between the ISF module and the calling party and a session channel between the ISF module and the called party may be established, so that, the calling party may send a message including content of the plurality of media types to the called party based on the session channels, t hereby improving user experience of service inter-working between the calling party, that is, a CPM user, and the called party, that is, a non-CPM user, and extending the use of the CPM service.

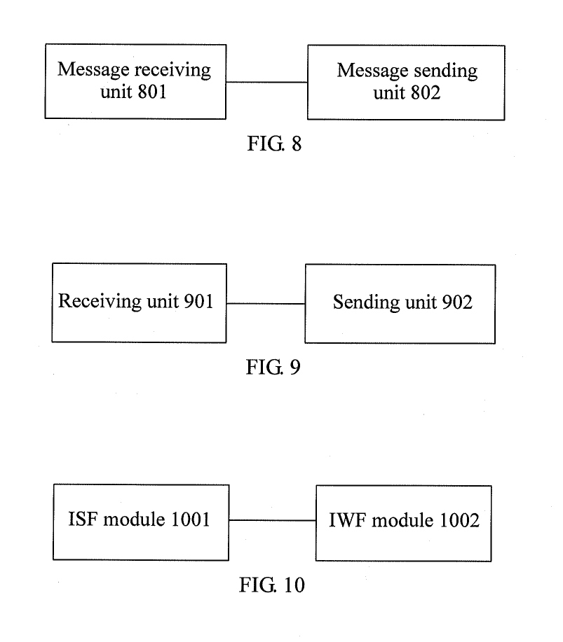

FIG. 8 is an ISF module according to another embodiment of the present invention, and the ISF module includes a message receiving unit 801, and a message sending unit 802.

The message receiving unit 801 is configured to receive a session INVITE message sent by a calling party, where the session INVITE message carries information about the called party, information about the media type of the current session, information about media types used in the session, and an identifier of the current session. The message sending unit 802 is configured to send, according to the information about the services activated by the called party and the information about the media types carried in the session INVITE message, an INVITE message carrying the information about the called party, the information about media type, and the identifier of the current session to IWF modules each corresponding to information about one media type in the session and information about services activated by a called party, and the IWF modules receiving the INVITE message convert the INVITE message and then send the converted INVITE message to the called party. The message receiving unit 801 is further configured to receive an agreement response message returned by the called party.

Furthermore, according to the embodiment of the present invention, before the message sending unit 802 of the ISF module sends the INVITE message carrying the information about the called party, the information about the media type, and the identifier of the current session, the message sending unit 802 is further configured to send the session INVITE message to the IWF module corresponding to the information about the media type of the current session. Before the message receiving unit 801 receives the INVITE message carrying the information about the called party, the information about the media type, and the identifier of the current session, the message receiving unit 801 is further configured to receive a message about not supporting the media type of the session returned by the IWF module corresponding to the information about the media type of the current session.

Furthermore, according to the embodiment of the present invention, after the message receiving unit 801 of the ISF module receives the session INVITE message sent by the calling party, the message receiving unit 801 is further configured to acquire the information about services activated by the called party according to the information about the called party.

FIG. 9 is an ISF module according to another embodiment of the present invention, and the ISF module includes a receiving unit 901 and a sending unit 902.

The receiving unit is configured to receive a session INVITE message sent by a calling party, where the session INVITE message carries information about the called party and information about at least two media types used in the session.

The sending unit is configured to send, according to the information about services activated by the called party and the information about the media types carried in the session INVITE message, an INVITE message carrying the information about the called party and the information about the media type to IWF modules each corresponding to information about one media type and information about services activated by a called party, so that the IWF modules having received the INVITE message convert the INVITE message and then send the converted INVITE message to the called party respectively. The receiving unit 901 is further configured to receive an agreement response message returned by the called party.

Definitely, according to the embodiment of the present invention, the ISF module may implement any function capable of being implemented by the ISF modules in FIGS. 4, 5, and 6, and will not be described in detail herein again.

FIG. 10 is a device according to an embodiment of the present invention, and the device includes an ISF module 1001 and an IWF module 1002. The ISF module 1001 is configured to receive content which is corresponding to at least two media types and is sent by a calling party, and send, according to the media types of the content, the content to the IWF module 1002 corresponding to information about the media types. The IWF module 1002 is configured to send the received content to a called party.

Furthermore, according to this embodiment, the ISF module 1001 may implement any function capable of being implemented by the ISF modules in FIGS. 4, 5, 6, 7, and 8, and will not be described in detail herein again. The IWF module 1002 may be configured to implement any corresponding function of the IWF modules in FIGS. 4, 5, and 6, and will not be described in detail herein again.

Through the description of the above implementation manner, those skilled in the art may clearly know that the present invention may be realized by using software and necessary universal hardware platform, and may be definitely realized by using hardware, but under many situations, the former one is the most preferred implementation manner. Based on such understanding, the technical solutions of the present invention or parts of the technical solutions of the present invention making contributions to the prior art are substantially presented in the form of a software product. The computer software product is stored in a storage medium, which includes a plurality of instructions for enabling the mobile devices (such as a mobile phone, a personal computer, and a media player) to execute the methods according to the embodiments of the present invention. Here, the storage media is, for example, a Read Only Memory (ROM)/Random Access Memory (RAM), a magnetic disk, or an optical disk.

It will be apparent to those skilled in the art that various modifications and variations can be made to the present invention without departing from the scope or spirit of the invention. In view of the foregoing, it is intended that the present invention cover modifications and variations of this invention provided they fall within the scope of the following claims and their equivalents.

1. A method for service inter-working, comprising:
receiving content which corresponds to at least two media types and is sent by a calling party; and
sending, according to the media types of the content, the content to Inter-Working Function (IWF) modules each corresponding to one media type, so that the IWF modules send the received content to a called party respectively.

2. The method according to claim 1, wherein before receiving the content which is corresponds to at least two media types and is sent by the calling party, the method further comprises:
establishing session channels with the calling party and the called party.

3. The method according to claim 2, wherein establishing the session channels with the calling party and the called party specifically comprises:
receiving a session INVITE message sent by the calling party, wherein the session INVITE message carries information about the called party and information about at least two media types used in the session;
sending, according to the information about services activated by the called party and the information about the media types carried in the session INVITE message, an INVITE message carrying the information about the called party and the information about the media type to IWF modules each corresponding to information about one media type and information about services activated by the called party, so that the IWF modules having received the INVITE message convert the INVITE message and then send the converted INVITE message to the called party respectively; and
receiving an agreement response message returned by the called party.

4. The method according to claim 3, wherein the session channels through the IWF modules between the calling party and the called party exist, and the session INVITE message further carries an identifier of the current session and information about a media type of the current session; the information about the media types used in the session comprises the information about the media type of the current session; the sending, according to the information about the media types carried in the session INVITE message and the information about services activated by the called party, the INVITE message to the IWF modules each corresponding to information about one media type and the information about services activated by the called party specifically comprises:
sending the INVITE message to the IWF modules each corresponding to information about one media type other than the media type of the current session and the information about services activated by the called party.

5. The method according to claim 3, wherein the session channels through the IWF modules between the calling party and the called party exist, and the session INVITE message further carries the identifier of the current session and the information about the media type of the current session; the information about the media types used in the session does not comprise the information about the media type of the current session, and the method further comprises:
indicating the IWF module corresponding to the information about the media type of the current session to cancel the session channel between the IWF module corresponding to the information about the media type of the current session and the calling party.

6. The method according to claim 3, wherein after receiving the session INVITE message sent by the calling party, the method further comprises:
acquiring the information about services activated by the called party according to the information about the called party.

7. A method for establishing an inter-working session channel, comprising:
receiving a session INVITE message sent by a calling party, wherein the session INVITE message carries information about the called party and information about at least two media types used in the session;
sending, according to the information about services activated by the called party and the information about the media types carried in the session INVITE message, an INVITE message carrying the information about the called party and the information about the media type to Inter-Working Function (IWF) modules each corresponding to the information about one media types and information about services activated by a called party, so that the IWF modules having received the INVITE message convert the INVITE message and then send the converted INVITE message to the called party respectively; and
receiving an agreement response message returned by the called party.

8. The method according to claim 7, wherein the session channels through the IWF modules between the calling party and the called party exist, and the session INVITE message further carries an identifier of the current session and information about a media type of the current session; the information about the media types used in the session comprises the information about the media type of the current session, and the method further comprises:
indicating the IWF module corresponding to the information about the media type of the current session to cancel a session channel between the IWF module corresponding to the information about the media type of the current session and the calling party.

9. The method according to claim 7, wherein the session channels through the IWF modules between the calling party and the called party exist, and the session INVITE message further carries an identifier of the current session and information about a media type of the current session; the information about the media type of the current session is unavailable, and the method further comprises:
indicating the IWF module corresponding to the information about the media type of the current session to cancel session channels between the IWF module corresponding to the information about the media type of the current session and the calling party and between the IWF module and the called party.

10. The method according to claim 7, wherein after receiving the session INVITE message sent by the calling party, the method further comprises:
acquiring the information about services activated by the called party according to the information about the called party.

11. A method for establishing an inter-working session channel, comprising:
receiving a session INVITE message sent by a calling party, wherein the session INVITE message carries information about the called party, information about a media type of the current session, information about media types used in the session, and an identifier of the current session;
sending an INVITE message carrying the information about the called party, the information about the media type used in the session and the identifier of the current session to Inter-Working Function (IWF) modules each corresponding to the information about one media type used in the session and information about services activated by the called party according to the information about the media types used in the session and carried in the session INVITE message and the information about services activated by the called party, so that the IWF modules having received the INVITE message convert the INVITE message and then send the converted INVITE message to the called party; and
receiving an agreement response message returned by the called party.

12. The method according to claim 11, wherein before sending the INVITE message carrying the information about the called party, the information about the media types used in the session, and the identifier of the current session, the method further comprises:
sending the session INVITE message to the IWF module corresponding to the information about the media type of the current session, and receiving a message about not supporting the media type of the session returned by the IWF module corresponding to the information about the media type of the current session.

13. The method according to claim 11, wherein after the receiving the session INVITE message sent by the calling party, the method further comprises:
acquiring the information about services activated by the called party according to the information about the called party.

14. An Inter-working Selection Function (ISF) module, comprising:
a content receiving unit, configured to receive content which is corresponds to at least two media types and is sent by a calling party; and
a content sending unit, configured to send, according to the media types of the content, the content to Inter-Working Function (IWF) modules each corresponding to one media type, so that the IWF modules send the received content to a called party respectively.

15. The ISF module according to claim 14, wherein
the content receiving unit is further configured to receive a session INVITE message sent by the calling party, wherein the session INVITE message carries information about the called party and information about at least two media types used in the session;
the content sending unit is further configured to send, according to the information about the media types used in the session and carried in the session INVITE message, an INVITE message carrying the information about the called party and the information about the media type to IWF modules each corresponding to information about one media type and information about services activated by the called party, so that the IWF modules having received the INVITE message convert the INVITE message and then send the converted INVITE message to the called party respectively; and the content having received unit is further configured to receive an agreement response message returned by the called party.

16. The ISF module according to claim 14, wherein
the content receiving unit is further configured to acquire the information about services activated by the called party according to the information about the called party.

17. An Inter-working Selection Function (ISF) module, comprising:
a message receiving unit, configured to receive a session INVITE message sent by a calling party, wherein the session INVITE message carries information about the called party, information about the media type of the current session, information about media types used in the session, and an identifier of the current session; and
a message sending unit, configured to send, according to the information about services activated by the called party and the information about the media types carried in the session INVITE message, the INVITE message carrying the information about the called party, the information about the media type, and the identifier of the current session to Inter-Working Function (IWF) modules each corresponding to information about one media type and information about services activated by a called party, wherein the IWF modules having received the INVITE message convert the INVITE message and then send the converted INVITE message to the called party; and
the message receiving unit is further configured to receive an agreement response message returned by the called party.

18. The ISF module according to claim 17, wherein
before sending the INVITE message carrying the called message, the information about the media type, and the identifier of the current session, the message sending unit is further configured to send the session INVITE message to the IWF module corresponding to the information about the media type of the current session; and
before receiving the INVITE message carrying the called message, the information about the media types, and the identifier of the current session, the message receiving unit is further configured to receive a message about not supporting the media type of the session returned by the IWF module corresponding to the information about the media type of the current session.

19. The ISF module according to claim 1, wherein
after receiving the session INVITE message sent by the calling party, the message receiving unit is further configured to acquire the information about services activated by the called party according to the information about the called party.

20. An Inter-working Selection Function (ISF) module, comprising:
a receiving unit, configured to receive a session INVITE message sent by a calling party, wherein the session INVITE message carries information about the called party and information about at least two media types used in the session; and
a sending unit, configured to send, according to the information about services activated by the called party and the information about the media types carried in the session INVITE message, an INVITE message carrying the information about the called party and the information about the media type to Inter-Working Function (IWF) modules corresponding to the information about the media types and information about services activated by a called party, so that the IWF modules having received the INVITE message convert the INVITE message and then send the converted INVITE message to the called party respectively;
wherein the receiving unit is further configured to receive an agreement response message returned by the called party.
